(19) United States
(12) Patent Application Publication
(10) Pub. No.: US 2007/0172607 A1
(43) Pub. Date: Jul. 26, 2007

(54) Method for improving the ozone stability of an inkjet recording element

(76) Inventor: Francoise M. Thomas, Chalon-sur-Saone (FR)

Correspondence Address: Patent Legal Staff, Eastman Kodak Company, Rochester, NY, 14650-2201, US

(21) Appl. No.: 11/568,264

(22) PCT Filed: Apr. 18, 2005
(86) PCT No.: PCT/EP05/04089

§ 371 Date: Oct. 25, 2006

(30) Foreign Application Priority Data
May 7, 2004 (FR) 0404912

(51) Int. Cl. B41M 5/50

(52) U.S. Cl. 428/32.34

(57) ABSTRACT

The present invention relates to a method for improving the ozone stability of an inkjet recording element. The present invention consists in using at least one alkyl sulfonic acid or one of its alkyl sulfonate salts in an inkjet recording element, said element comprising a support and at least one ink-receiving layer comprising at least one hydrosoluble binder and inorganic particles, for improving the ozone stability of said element. Preferably, the alkyl group is linear and comprises 3 to 8 carbon atoms.

### FIELD OF THE INVENTION

The present invention relates to a method for improving the ozone stability of an inkjet recording element.

### BACKGROUND OF THE INVENTION

Digital photography has been growing fast for several years and the general public now has access to efficient and reasonably priced digital cameras. Therefore people are seeking to be able to produce photographic prints from a simple computer and its printer, with the best possible quality.

Many printers, especially those linked to personal office automation, use the inkjet printing technique. There are two major families of inkjet printing techniques: continuous jet and drop-on-demand.

Continuous jet is the simpler system. Pressurized ink (3.10⁵ Pa) is forced to go through one or more nozzles so that the ink is transformed into a flow of droplets. In order to obtain the most regular possible sizes and spaces between drops, regular pressure pulses are sent using for example a piezoelectric crystal in contact with the ink with high frequency (up to 1 MHz) alternating current (AC) power supply. So that a message can be printed using a single nozzle, every drop must be individually controlled and directed. Electrostatic energy is used for this: an electrode is placed around the ink jet at the place where drops form. The jet is charged by induction and every drop henceforth carries a charge whose value depends on the applied voltage. The drops then pass between two deflecting plates charged with the opposite sign and then follow a given direction, the amplitude of the movement being proportional to the charge carried by each of them. To prevent other drops from reaching the paper, they are left uncharged: so, instead of going to the support they continue their path without being deflected and go directly into a container. The ink is then filtered and can be reused.

The other category of inkjet printer is drop-on-demand (DOD). This constitutes the basis of inkjet printers used in office automation. With this method, the pressure in the ink cartridge is not maintained constant but is applied when a character has to be formed. In one widespread system there is a row of 12 open nozzles, each of them being activated by a piezoelectric crystal. The ink contained in the head is given a pulse: the piezo element contracts with an electric voltage, which causes a decrease of volume, leading to the expulsion of the drop by the nozzle. When the element resumes its initial shape, it pumps into the reservoir the ink necessary for new printings. The row of nozzles is thus used to generate a column matrix, so that no deflection of the drop is necessary. One variation of this system consists in replacing the piezoelectric crystals by small heating elements behind each nozzle. The drops are ejected following the forming of bubbles of solvent vapor. The volume increase enables the expulsion of the drop. Finally, there is a pulsed inkjet system in which the ink is solid at ambient temperature. The print head thus has to be heated so that the ink liquefies and it can print. This enables rapid drying on a wider range of products than conventional systems.

There now exist new “inkjet” printers capable of producing photographic images of excellent quality. However, they cannot supply good proofs if inferior quality printing paper is used. The choice of printing paper is fundamental for the quality of the obtained image. The printing paper must combine the following properties: a printed image of high quality, rapid drying after printing, a smooth and glossy appearance, and good resistance of the image colors in time, which means especially good stability to ozone present in the atmosphere of the ink dyes.

In general, the printing paper comprises a support coated with one or more layers according to the properties required. Two main technologies have been developed. On the one hand, there is a non-porous printing paper, usually comprising layers of polymers, such as gelatin. This paper enables images that are glossy and ozone stable to be obtained because, once the polymer layer is dry, permeability to ozone is low. However, these papers, not being porous, have to swell to absorb the ink. This swelling slows ink absorption so that the ink can easily run just after printing.

Another paper has been developed to obtain a paper with rapid drying in order to increase printing output rates. This is a paper comprising a porous ink-receiving layer including colloidal particles used as receiving agent and a polymer binder. This porous paper absorbs the ink rapidly thanks to the pores existing between the particles.

The purpose of the receiving agent is to fix the dyes in the printing paper. The best-known inorganic receivers are colloidal silica or boehmite. For example, the European Patent Applications EP-A-976,571 and EP-A-1,162,076 describe inkjet recording elements in which the ink-receiving layer contains as inorganic receivers Ludox™ CL (colloidal silica) marketed by Grace Corporation or Dispal™ (colloidal boehmite) marketed by Sasol. However, printing paper comprising a porous ink-receiving layer can have poor ozone stability in time, which is demonstrated by a loss of color density. In particular this is due to the fact that the colloidal particles are easily accessible to ozone and the surface of these particles could catalyze the ozone degradation of the ink dyes.

To meet the new requirements of the market in terms of photographic quality, printing speed and color stability to ozone, it is necessary to propose a method enabling improvement of the stability to ozone of an image printed by inkjet on an inkjet recording element.

### SUMMARY OF THE INVENTION

The present invention relates to the use of at least one alkyl sulfonic acid or one of its alkyl sulfonate salts to improve the stability to ozone of an image printed by inkjet on an inkjet recording element, comprising a support and at least one ink-receiving layer including at least one hydrosoluble binder and inorganic particles. The alkyl sulfonic acid or its alkyl sulfonate salt can be introduced in the printing ink or in the ink-receiving layer of the inkjet recording element. The alkyl group can be linear or branched, substituted or not, and can comprise 3 to 8 carbon atoms.

The use of alkyl sulfonic acid or alkyl sulfonate salt enables the ozone stability of an image printed by inkjet on an inkjet recording element to be improved.

### BRIEF DESCRIPTION OF THE DRAWINGS

FIGS. 1 and 2 represent the percentage of dye remaining after exposure to ozone of the various inkjet recording elements.

### DETAILED DESCRIPTION OF THE INVENTION

An inkjet recording element comprises firstly a support. This support is selected according to the desired use. It can be a transparent or opaque thermoplastic film, in particular a polyester base film such as polyethylene terephthalate; cellulose derivatives, such as cellulose ester, cellulose triacetate, cellulose diacetate; polyacrylates; polyimides; polyamides; polycarbonates; polystyrenes; polyolefines; polysulfones; polyetherimides; vinyl polymers such as polyvinyl chloride; and mixtures thereof. The support can also be paper, both sides of which may be covered with a polyethylene layer. When the support comprising the paper pulp is coated on both sides with polyethylene, it is called Resin Coated Paper (RC Paper) and is marketed under various brand names. This type of support is especially preferred to constitute an inkjet recording element. The side of the support that is used can be coated with a very thin layer of gelatin or another composition to ensure the adhesion of the first layer on the support. To improve the adhesion of the ink-receiving layer on the support, the support surface can also have been subjected to a preliminary treatment by Corona discharge before applying the ink-receiving layer.

An inkjet recording element then comprises at least one ink-receiving layer comprising at least one hydrosoluble binder. Said hydrosoluble binder can be a hydrophilic polymer such as polyvinyl alcohol, poly(vinyl pyrrolidone), gelatin, cellulose ethers, poly(oxazolines), poly(vinylacetamides), poly(vinyl acetate/vinyl alcohol) partially hydrolyzed, poly(acrylic acid), poly(acrylamide), sulfonated or phosphated polystyrenes and polyesters, casein, zein, albumin, chitin, dextran, pectin, derivatives of collagen, agar-agar, guar, carragheenane, tragacanth, xanthan and others. Preferably, one uses gelatin or polyvinyl alcohol. The gelatin is that conventionally used in the photographic field. Such a gelatin is described in Research Disclosure, September 1994, No. 36544, part IIA. Research Disclosure is a publication of Kenneth Mason Publications Ltd., Dudley House, 12 North Street, Emsworth, Hampshire PO10 7DQ, United Kingdom. The gelatin can be obtained from SKW and the polyvinyl alcohol from Nippon Gohsei, or Air Product with the name Airvol® 130.

The ink-receiving layer also comprises, as receiving agent, inorganic particles. In one embodiment, said inorganic particles are based on metal oxide or metal hydroxide. Preferably, the inorganic particles are based on alumina, silica, titanium, zirconium, or mixtures thereof. Preferably, the inorganic particles are selected from the group consisting of boehmites, fumed aluminas, colloidal silicas, fumed silicas, calcium silicates, magnesium silicates, zeolites, kaolin, bentonite, silicon dioxide, and titanium dioxide. According to another embodiment, the inorganic particles are based on calcium carbonates, or barium carbonates.

The amounts of the inorganic particles and hydrosoluble binder are those generally used for porous inkjet recording elements.

Those skilled in the art know that such inorganic particles, used alone as a receiving agent in ink-receiving layers, do not enable the required ozone stability of the image to be obtained for inkjet recording element. Also, according to the present invention, the use of at least one alkyl sulfonic acid or one of its alkyl sulfonate salts enables the ozone stability of the dyes making up the image to be improved. The alkyl group can be linear or branched, substituted or not. Preferably, the alkyl group is linear and not substituted and comprises 3 to 8 carbon atoms. Preferably, alkyl sulfonic acids are used in salt form. In this case, preferably an alkyl sulfonate is used selected from the group consisting of sodium propane sulfonate, sodium hexane sulfonate, and sodium octane sulfonate.

The concentration in alkyl sulfonic acid or alkyl sulfonate salt can be between 0.1 percent and 10 percent by weight with reference to the total weight of the wet receiving layer. Preferably, the concentration in alkyl sulfonic acid or alkyl sulfonate salt is between 3 percent and 10 percent by weight with reference to the total weight of the wet receiving layer.

The alkyl sulfonic acid or its alkyl sulfonate salt is added to the layer composition intended to be coated on the support to constitute the ink-receiving layer of the recording element described above. To produce this composition, in preference, the alkyl sulfonic acid or its alkyl sulfonate salt in the form of an aqueous solution and the inorganic particles are first mixed together and then the hydrosoluble binder is added. The composition then has the form of an aqueous solution or a dispersion containing all the necessary components. The composition can also comprise a surfactant to improve its coating properties.

The composition can be layered on the support according to any appropriate coating method, such as blade, knife or curtain coating. The composition is applied with a thickness between approximately 100 μm and 300 μm in the wet state. The composition forming the ink-receiving layer can be applied to both sides of the support. It is also possible to provide an antistatic or anti-winding layer on the back of the support coated with the ink-receiving layer.

The inkjet recording element can comprise, besides the ink-receiving layer described above, other layers having another function, arranged above or below said ink-receiving layer. The ink-receiving layer as well as the other layers can comprise any other additives known to those skilled in the art to improve the properties of the resulting image, such as UV ray absorbers, optical brightening agents, antioxidants, plasticizers, etc.

According to the present invention, the use of at least one alkyl sulfonic acid or one of its alkyl sulfonate salts improves the stability to ozone of an image printed by inkjet on an inkjet recording element, comprising a support and at least one ink-receiving layer including at least one hydrosoluble binder and inorganic particles. As described above, the alkyl sulfonic acid or its alkyl sulfonate salts can be introduced from the start in the ink-receiving layer during the manufacture of the recording element. The alkyl sulfonic acid or its alkyl sulfonate salts can also be introduced in the recording element by means of the ink that penetrates into the ink-receiving layer. When the ink contains an alkyl sulfonic acid or an alkyl sulfonate salt and an appropriate dye, the color image corresponding to the dye in the ink printed on an inkjet recording element has good stability to ozone over time.

This invention can be used for any type of inkjet printer as well as for all the inks developed for this technology.

The following examples illustrate the present invention without however limiting its scope.

1) Preparation of Coating Compositions to Constituting an Ink-Receiving Layer Coated on a Support

As hydrosoluble binder, polyvinyl alcohol was used (Gohsenol™ GH23 marketed by Nippon Gohsei) diluted to 9 percent in osmosis water.

Alkyl sulfonic acids are used in the form of sulfonate salts as defined in table I below:

TABLE I

| Alkyl sulfonate salt | Mole weight (g/mol) |
|---|---|
| monohydrated sodium 1-propane sulfonate | 164.15 |
| sodium 1-hexane sulfonate | 188.22 |
| monohydrated sodium 1-octane sulfonate | 216.28 |

For each alkyl sulfonate salt defined in table I, a concentrated aqueous solution at 0.53 mole/l is prepared.

The inorganic particles used are given below in Table II:

TABLE II

| Inorganic particle | Brand | Charge | Supplier |
|---|---|---|---|
| Fumed alumina | CAB-O-SPERSE ® | Positive | Cabot |
| (dispersion at 40 percent) | PG003 | | Corporation |
| Colloidal silica | Ondeo | Negative | Ondeo Nalco |
| (dispersion at 40 percent) | Nalco ®2329 | | Corporation |

All the compositions resulted from mixing:
0 ml to 8 ml of solution concentrated in alkyl sulfonate salt (see table III below)
7.5 g of inorganic particles (dispersion at 40 percent)
4 g polyvinyl alcohol (aqueous solution at 9 percent)
Water to 22 g

First the aqueous solution concentrated in alkyl sulfonate salt is mixed with water, then the dispersion of inorganic particles is added. The mixture is stirred for three hours using a roller stirrer and 10-mm diameter glass beads. Then polyvinyl alcohol is added and stirred for 18 hours using a roller stirrer.

2) Preparation of Inkjet Recording Elements

To do this, a Resin Coated Paper type support was placed on a coating machine, first coated with a very thin gelatin layer, and held on the coating machine by vacuum. This support was coated with a composition as prepared according to paragraph 1 using a filmograph to obtain a wet thickness of 200 μm. Then, it was left to dry at ambient air temperature (21° C.).

The resulting recording elements correspond to the examples shown in table III below giving the alkyl sulfonate salt and the concentration used in the ink-receiving layer, as well as the inorganic particles used:

TABLE III

| | | | concentrated |
|---|---|---|---|
| | Inorganic particles | | solution of alkyl |
| Recording | added to the ink- | Alkyl | sulfonate in the |
| element | receiving layer | sulfonate | mixture (ml) |
| Ex. 1 | Fumed alumina | — | 0 |
| (comp.) | CAB-O-SPERSE ® PG003 | | |
| Ex. 2 | Fumed alumina | Propane | 8 |
| (inv.) | CAB-O-SPERSE ® PG003 | sulfonate | |
| Ex. 3 | Fumed alumina | Hexane | 2 |
| (inv.) | CAB-O-SPERSE ® PG003 | sulfonate | |
| Ex. 4 | Fumed alumina | Hexane | 4 |
| (inv.) | CAB-O-SPERSE ® PG003 | sulfonate | |
| Ex. 5 | Fumed alumina | Octane | 8 |
| (inv.) | CAB-O-SPERSE ® PG003 | sulfonate | |
| Ex. 6 | Colloidal silica | — | 0 |
| (comp.) | Nalco ® 2329 | | |
| Ex. 7 | Colloidal silica | Propane | 2 |
| (inv.) | Nalco ® 2329 | sulfonate | |
| Ex. 8 | Colloidal silica | Propane | 4 |
| (inv.) | Nalco ® 2329 | sulfonate | |
| Ex. 9 | Colloidal silica | Propane | 8 |
| (inv.) | Nalco ® 2329 | sulfonate | |
| Ex. 10 | Colloidal silica | Hexane | 2 |
| (inv.) | Nalco ® 2329 | sulfonate | |
| Ex. 11 | Colloidal silica | Hexane | 4 |
| (inv.) | Nalco ® 2329 | sulfonate | |
| Ex. 12 | Colloidal silica | Hexane | 8 |
| (inv.) | Nalco ® 2329 | sulfonate | |
| Ex. 13 | Colloidal silica | Octane | 2 |
| (inv.) | Nalco ® 2329 | sulfonate | |
| Ex. 14 | Colloidal silica | Octane | 4 |
| (inv.) | Nalco ® 2329 | sulfonate | |
| Ex. 15 | Colloidal silica | Octane | 8 |
| (inv.) | Nalco ® 2329 | sulfonate | |

3) Evaluation of the Ozone Stability of the Image Over Time

To evaluate ozone stability over time, a dye fading test by exposure to ozone was performed for each resulting recording element. To do this, targets of magenta color to the maximum density were printed on each recording element using a KODAK® PPM 200 printer and related ink. The targets were analyzed using a Gretag Macbeth Spectrolino densitometer that measured the intensity of the color. Then the recording elements were placed in the dark in a room with controlled ozone atmosphere (60 ppb) for ten days. Then any deterioration of magenta color density was measured using the densitometer.

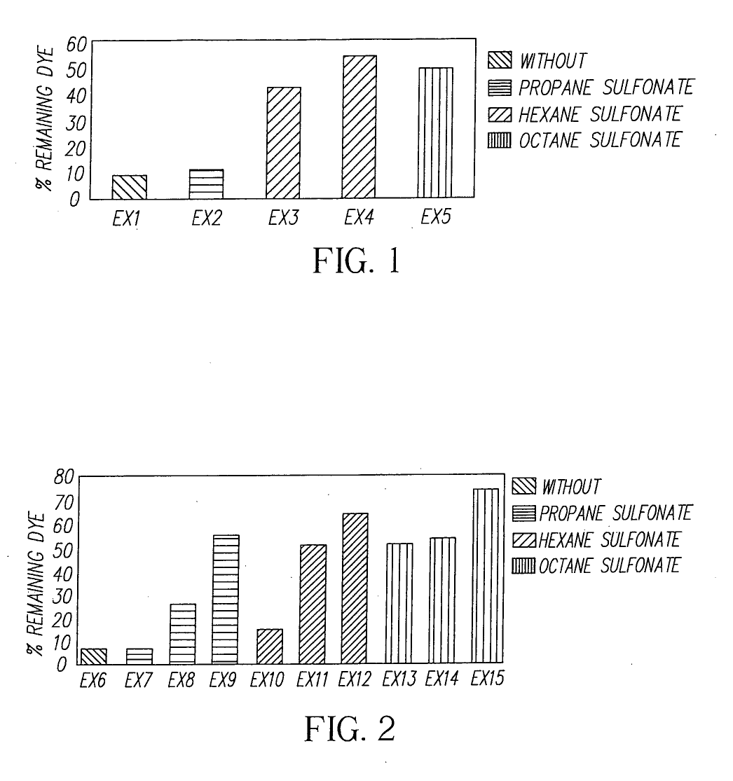

FIG. 1 represents the percentage of dye remaining, observed for the maximum density for the magenta target after ten days exposure to ozone for examples 1 to 5.

FIG. 2 represents the percentage of dye remaining observed for the maximum density for the magenta target after ten days exposure to ozone for examples 6 to 15.

It may be noted that the use of an alkyl sulfonate salt in inkjet recording elements (Examples 2 to 5 and 7 to 15) enabled the ozone stability of the printed image to be better than the ozone stability of an image printed on the recording elements not containing alkyl sulfonate compounds (Examples 1 and 6), and whatever the inorganic particles used.

Furthermore, FIGS. 1 and 2 show that the stability to ozone of the inkjet recording elements comprising alkyl sulfonic acid or alkyl sulfonate salt increases on the one hand with the concentration in alkyl sulfonate and on the other hand with the length of chain of the alkyl group, and whatever the inorganic particle used.

4) Use of Alkyl Sulfonate in the Printing Ink

Aqueous solutions are prepared comprising 0.2 g/l of dyes commonly used in inks for inkjet printing.

The dyes are the magenta dye Sulforhodamine Acid Red 52 (CAS 3520-42-1), magenta dye Kodak (KAN 650 604) and cyan dye Acid Blue 9 (CAS 2650-18-2).

To these solutions, various alkyl sulfonates are added (10 percent by weight). Various commercial paper supports are used for inkjet printing which are photo paper Premium C13S041287 from EPSON and paper Instant-Dry Photographic Glossy Paper/220 g from KODAK.

These paper supports are immersed in the inks thus prepared. The various colored papers obtained correspond to the examples shown in table IV below giving the alkyl sulfonate salt and the dye used in the ink, as well as the commercial reference of the paper support.

Then the stability to ozone of these colored papers is assessed by a dye fading test by exposure to ozone by putting them in the dark in a room with controlled ozone atmosphere (60 ppb) for several days. Then using the densitometer, the percentage of observed dye remaining is measured at the end of 10 days exposure to ozone.

TABLE IV

| | Commercial | | | |
|---|---|---|---|---|
| Recording | name of the | Alkyl | | Percent of |
| element | paper support | sulfonate | Dye | remaining dye |
| Ex 16 | EPSON | — | Acid Red | 48 |
| (comp.) | | | 52 | |
| Ex 17 | EPSON | Hexane | Acid Red | 98 |
| (inv.) | | sulfonate | 52 | |
| Ex 18 | EPSON | — | Magenta | 22 |
| (comp.) | | | Kodak | |
| Ex 19 | EPSON | Hexane | Magenta | 50 |
| (inv.) | | sulfonate | Kodak | |
| Ex 20 | EPSON | — | Acid Blue | 65 |
| (comp.) | | | 9 | |
| Ex 21 | EPSON | Hexane | Acid Blue | 95 |
| (inv.) | | sulfonate | 9 | |
| Ex 22 | KODAK | — | Magenta | 45 |
| (comp.) | | | Kodak | |
| Ex 23 | KODAK | Butane | Magenta | 67 |
| (inv.) | | sulfonate | Kodak | |
| Ex 24 | KODAK | Hexane | Magenta | 72 |
| (inv.) | | sulfonate | Kodak | |
| Ex 25 | KODAK | Octane | Magenta | 94 |
| (inv.) | | sulfonate | Kodak | |

The results of table IV show that, for the inkjet recording elements in which an alkyl sulfonate salt was introduced via the ink, the percentage of dye remaining after exposure to ozone is greater than that shown by the recording elements not containing alkyl sulfonate compounds. The recording elements comprising an alkyl sulfonate salt thus have better stability to ozone.

1) Use of at least one alkyl sulfonic acid or one of its alkyl sulfonate salts for improving the ozone stability of an image printed by inkjet on an inkjet recording element, said element comprising a support and at least one ink-receiving layer including at least one hydrosoluble binder and inorganic particles.

2) The use according to claim 1, wherein the alkyl sulfonic acid or its alkyl sulfonate salt is introduced via the printing ink.

3) The use according to claim 1, wherein the alkyl sulfonic acid or its alkyl sulfonate salt is introduced in the ink-receiving layer of the recording element.

4) The use according to claim 1, wherein the alkyl group is linear or branched, substituted or not, and comprises 3 to 8 carbon atoms.

5) The use according to claim 1, wherein the alkyl sulfonate is selected from the group consisting of sodium propane sulfonate, sodium hexane sulfonate, and sodium octane sulfonate.

6) The use according to claim 1, wherein the concentration of alkyl sulfonic acid or alkyl sulfonate salt is between 0.1 percent and 10 percent by weight compared with the total weight of the wet receiving layer.

7) The use according to claim 6, wherein the concentration of alkyl sulfonic acid or alkyl sulfonate salt is between 3 percent and 10 percent by weight compared with the total weight of the wet receiving layer.

8) The use according to claim 1, wherein the inorganic particles are based on metal oxide or metallic hydroxide.

9) The use according to claim 8, wherein the inorganic particles are based on alumina, silica, titanium, zirconium, or mixtures thereof.

10) The use according to claim 9, wherein the inorganic particles are selected from the group consisting of boehmites, fumed alumina, colloidal silica, fumed silica, calcium silicates, magnesium silicates, zeolites, kaolin, bentonite, silicon dioxide, and titanium dioxide.

11) The use according to claim 1, wherein the inorganic particles are based on calcium carbonates or barium carbonates.

12) The use according to claim 1, wherein the hydrosoluble binder is gelatin or polyvinyl alcohol.
